(19) United States
(12) Patent Application Publication
(10) Pub. No.: US 2010/0296666 A1
(43) Pub. Date: Nov. 25, 2010

(54) APPARATUS AND METHOD FOR NOISE CANCELLATION IN VOICE COMMUNICATION

(75) Inventor: Chun-Cheng LIN, Hsinchu City (TW)

Correspondence Address: EGBERT LAW OFFICES, 412 MAIN STREET, 7TH FLOOR, HOUSTON, TX, 77002, US

(73) Assignee: NATIONAL CHIN-YI UNIVERSITY OF TECHNOLOGY, Taiping City (TW)

(21) Appl. No.: 12/471,429

(22) Filed: May 25, 2009

(51) Int. Cl. G10K 11/16

(52) U.S. Cl. 381/71.6

(57) ABSTRACT

The present invention provides an apparatus and method for noise cancellation of voice communication. The apparatus includes a main body, loudspeaker, in-ear microphone, speaking microphone and adaptive control system. The method includes an external noise microphone arranged externally onto the main and used to acquire the noise outside of the ear drum, which is taken as the reference noise signal of adaptive control system. The in-ear anti-noise is estimated, so that the noise disturbance can be reduced when the receiving end receives remote voices. After noises and near-end voices are separated from near-end voices subjecting to noise disturbance, so that the accuracy of estimating anti-noise and the applicability of active noise cancellation is increased.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a voice communication apparatus, and more particularly to an innovative apparatus and method.

2. Description of Related Art Including Information Disclosed Under 37 CFR 1.97 and 37 CFR 1.98.

The commonly-used noise suppression technology allows passively absorbing the energy of noises by various acoustical materials. However, the wavelength of voice in a low-frequency state is much bigger than the thickness of common acoustical materials, e.g. the wavelength of 100 Hz voice is about 3˜4 m on sea level at normal temperature. Hence, the transmittance of low-frequency voice cannot be blocked off unless extremely thick noise-absorbing devices are employed. Such passive noise-cancellation technology is not ideal for low-frequency noises in application. Thus, the passive noise cancellation technology must strike a balance in efficient elimination of low-frequency noises and bulky and costly noise-absorbing equipment.

To resolve efficiently the aforementioned problems, a theory of active noise control (ANC) has been researched and developed comprehensively in recent years. The basic principle of ANC system is that, nearby the source of noises, waveform synthesis is employed to generate an anti-noise wave of phase difference 180°, with the same waveform and size as an original noise waveform, thus reducing the noise level by generating destructive disturbance against the noise source. FIG. 1 depicts the noise waveform (L1), anti-noise waveform (L2), and residual noise waveform (L3) after superimposition of noise and anti-noise waveforms.

As seen, the active noise cancellation technology depends on the size of anti-noise waveform, estimation and control accuracy of phase.

In practice, it is hoped that no noises are contained in the fluctuating air transferred to the human ears, or that the noises are suppressed to a maximum possible extent. As ANC technology is concerned, this objective can be realized by two ways: first, anti-noise sources (with the same waveform and size as noise signals, but with contrary phase) are mounted at the source of noises for eliminating the noises therein. However, except for some special facilities, automobile exhaust tail pipes and cooling air pipelines of central air-conditioning systems are arranged in parallel with the direction of voice transmission; thus, everyday noises are generally transmitted in all directions. In such a case, in order to remove the noise signal in every direction, the voice sources and all relevant 3D sound fields and their complexity on all transmission routes need to be considered. In an extremely complex environment with multiple voice sources and transmission routes, this method makes the known ANC system very bulky and complicated without cost-effectiveness. Secondly, other than trying to produce a big noiseless space, it is only necessary to estimate the external noise signals and generate a signal of the same waveform and size, but with a contrary phase, so as to form a very small noiseless space. Due to the advantages of such technology in estimation of noise waveform, generation and control of anti-noise waveform, some noise-reduction earphones are currently developed to reduce the noise nearby ear drums by output of anti-noise waveform with the loudspeaker in the earphone.

The control system for generating inverting noises is mainly categorized into a fixed parameter and adaptive ones. Of which, the fixed parameter control system is to generate inverting noises from the input noise signals through an inverter circuit, but the inverting noises cannot be fully eliminated due to unmatched size and phase of the inverter circuit. To compensate the phase delay of the control system in response to time-varying noises, an adaptive control system capable of regulating the parameters must be employed. At present, a feedback adaptive ANC system is applied to earphone, into which a mini-microphone is embedded to acquire the noises. Then, the noises are output by the built-in loudspeaker after anti-noise is estimated by the adaptive control system for noise cancellation. However, the main restrictions of this feedback active control system lie in that, after anti-noises are output by the loudspeaker and internal noises are combined with anti-noises, the microphone in the earphone could acquire the residual noises, but the reference noise signals required by adaptive control system cannot be acquired directly, but by means of synthesis technology. In the event of inaccurate reference noise signals, the estimated anti-noises will become inaccurate, thus the noise cancellation performance will be depressed significantly.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Based on the innovative present invention, an independent external noise microphone is arranged on a main body, and the main external noise can be taken as the reference input signal of anti-noise estimation filter (referred to as feedforward adaptive control system), it is possible to improve the accuracy of estimating anti-noises and the performance of active noise cancellation.

Elimination of noise disturbance against main near-end voice: based on the near-end voice estimation filter, the main external noise obtained by independent noise microphone is taken as a reference input signal, and used to separate secondary external noise and main near-end voice in the speaking microphone, so the main near-end voice without noise disturbance can be sent out.

Avoiding interruption of a secondary near-end voice against the estimation of anti-noises, an anti-noise estimation filter adjusts the parameters of filter based on the residual noise; thus, after near-end voice enters into the in-ear microphone, the parameter adjustment by anti-noise estimation filter will be affected. To this end, the secondary near-end voice estimation filter is proposed in the present invention, which takes the estimated value of main near-end voice as the reference input signal, and separates the secondary near-end voice from in-ear microphone, thereby avoiding the interruption of secondary near-end voice against the estimation of anti-noises.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a schematic view of a comparison diagram of noise waveform, anti-noise waveform and residual noise waveform.

FIG. 2 shows a schematic view, showing the present invention applied to an external earphone microphone.

FIG. 3 shows a schematic view, showing the present invention applied to a headphone microphone.

FIG. 4 shows a schematic view, showing the present invention applied to a mobile phone.

FIG. 5 shows a block chart of the adaptive control system of the present invention.

FIG. 6 shows a block chart of the adaptive control system for estimating 2^{nd} path transfer function of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

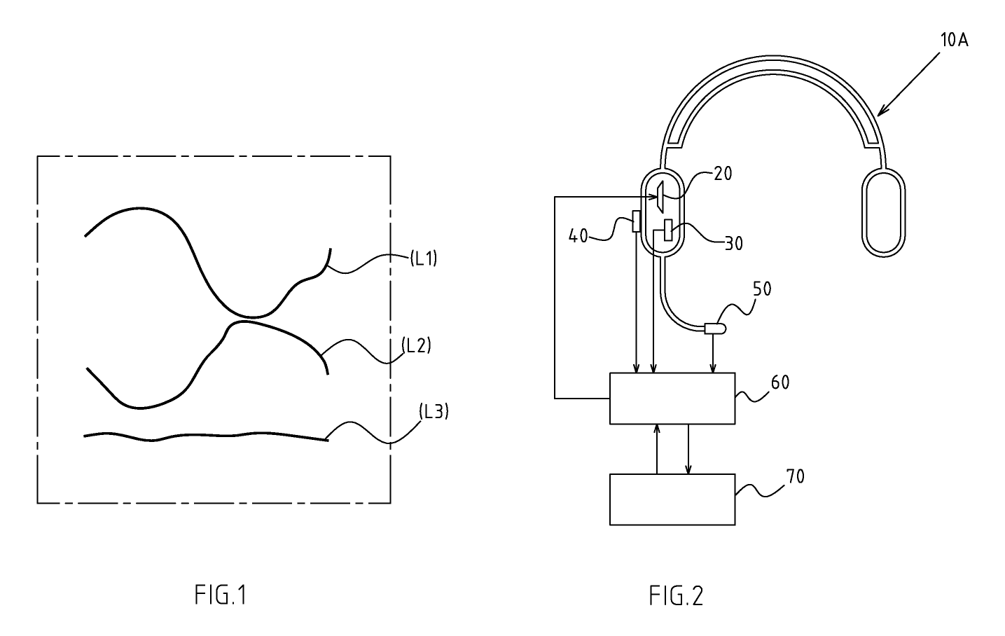

FIGS. 2˜4 depict preferred embodiments of noise cancellation structure and method of voice communication apparatus of the present invention, which, however, are provided for only explanatory objectives with respect to the patent claims.

The present invention provides a noise cancellation structure of feedforward noise control technology for the voice communication apparatus (e.g. external earphone microphone, headphone microphone, mobile phone, fixed telephone). The noise cancellation structure can be arranged onto the external earphone microphone and headphone microphone, or embedded into the telephone. Referring to FIGS. 2, 3 and 4, the noise cancellation structure is arranged onto a two-way voice communication system covering external earphone microphone 10A, headphone microphone 10B and mobile phone 10C with feedforward noise control technology.

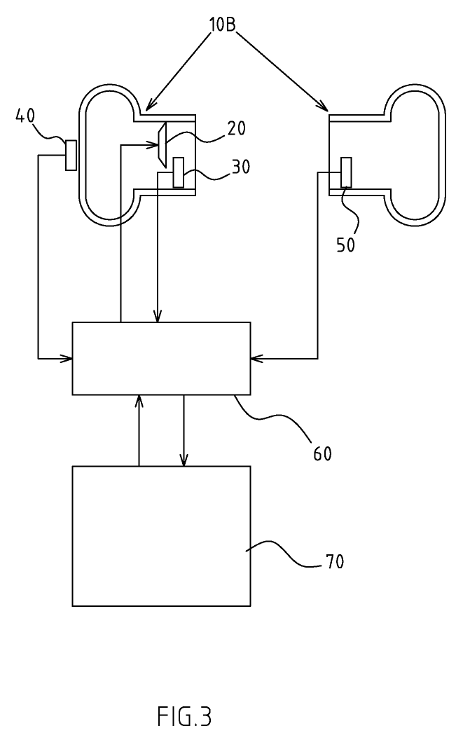

The noise canceling apparatus includes a main body, which is referred to as the main body of a two-way voice communication device (e.g. mobile phone and fixed telephone). There is an external earphone microphone 10A shown in FIG. 2, headphone microphone 10B shown in FIG. 3, and mobile phone 10C shown in FIG. 3.

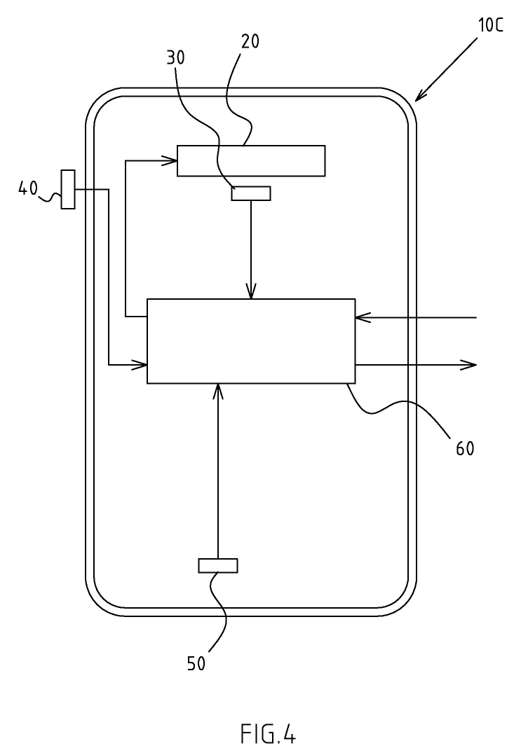

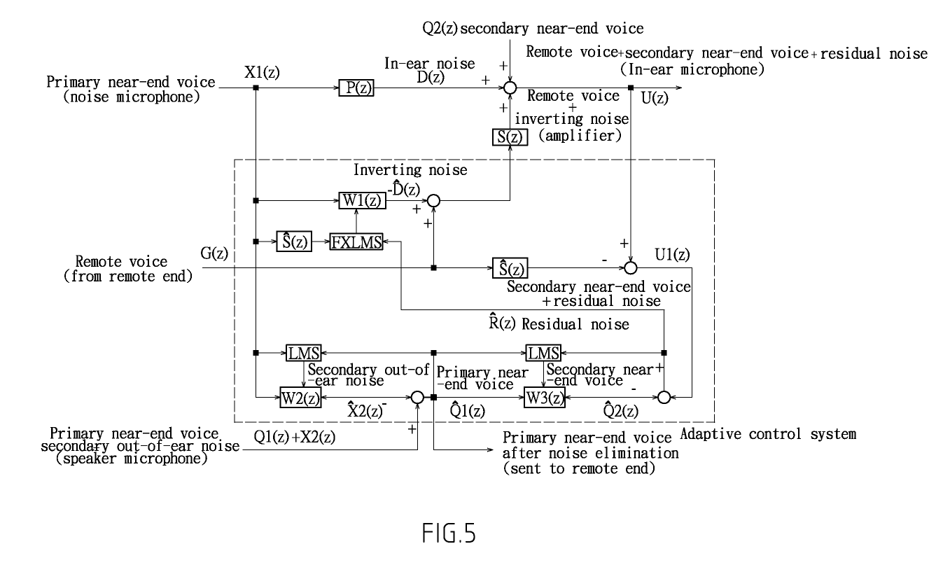

A loudspeaker 20 is arranged into the earphone of external earphone microphone 10A (shown in FIG. 2) or into the earphone of the headphone microphone 10B (shown in FIG. 3) or into the mobile phone 10C (shown in FIG. 4). The loudspeaker 20 is used to output anti-noises and remote voices. The purpose of outputting anti-noises is to remove the noises nearby ear drums, which are called as in-ear noises. Remote voice refers to the voice transmitted from the other party during two-way voice communication.

An in-ear microphone 30 is arranged into the earphone of external earphone microphone 10A and located nearby the loudspeaker 20 (shown in FIG. 2) or into the earphone of the headphone microphone 10B and located nearby the loudspeaker 20 (shown in FIG. 3) or into the mobile phone 10C and located nearby the loudspeaker 20 (shown in FIG. 4). The in-ear microphone 30 is a mini microphone used to acquire the voices in the earphone, including residual noise, remote voice and secondary near-end voice. The residual noise refers to the noise generated when anti-noise output by the loudspeaker 20 and in-ear noise are neutralized, and secondary near-end voice refers to the voice of speaker transmitted from the mouth to the ear.

An external noise microphone 40 is arranged externally onto the earphone of external earphone microphone 10A (shown in FIG. 2) or externally onto the earphone of the headphone microphone 10B (shown in FIG. 3) or on the back of the mobile phone 10C (shown in FIG. 4). The external noise microphone 40 is a single-directional microphone used to acquire the noises outside of the ear; the single-directional noise microphone must be arranged in such a manner to receive the main near-end voices from the speakers.

A speaking microphone 50 is arranged onto external earphone microphone 10A near the mouth of the speaker (shown in FIG. 2) or onto the headphone microphone 10B (shown in FIG. 3) or at the bottom of the mobile phone 10C (shown in FIG. 4). The speaking microphone 50 is an omnidirectional microphone used to receive main near-end voices from the speakers or environmental noises. The noise received from the speaking microphone refers to secondary external noise in the present invention.

An adaptive control system 60 takes a digital signal processor as its core of operation. It can be arranged independently outside of external earphone microphone 10A (shown in FIG. 2), or outside of headphone microphone 10B (shown in FIG. 3), or inside the mobile phone 10C (shown in FIG. 4). The adaptive control system 60 of the present invention mainly comprises: anti-noise estimation filter, primary near-end voice estimation filter and secondary near-end voice estimation filter. Moreover, main external noise obtained by the external noise microphone 40 is taken as the reference input signal of anti-noise estimation filter. Furthermore, the block 70 in FIGS. 2, 3 represents a telephone (e.g. mobile phone, or fixed telephone), through which the main near-end voice subject to noise elimination by the adaptive control system 60 will be sent out.

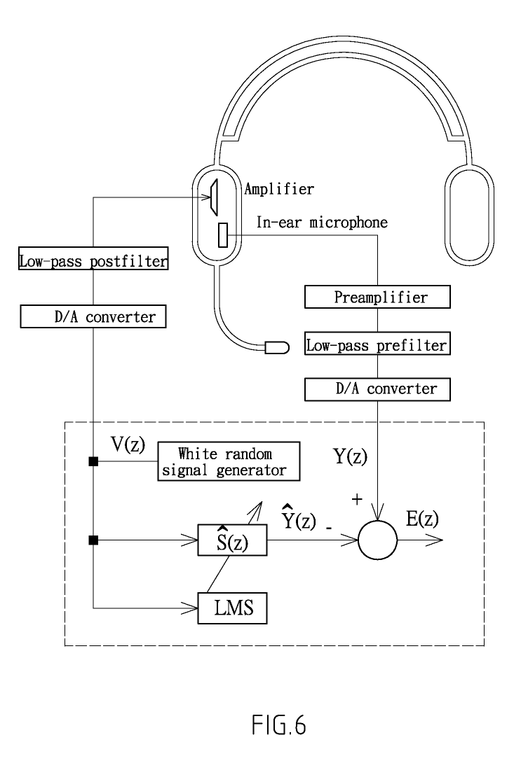

The block chart of adaptive control system based on LMS (least-mean-square) and FXLMS (filtered-X least-mean-square) algorithms is depicted in FIG. 5, wherein z transformation representation is sued to represent I/O signals, estimation filter or system device. P(z) is equivalent transfer function of the primary path, representing the sound transmission path from noise microphone to in-ear microphone. S(z) is the equivalent transfer function of the second path, covering various electronic devices required when voice is intercepted by the microphone (including: microphone, preamplifier, low-pass prefilter, A/D converter), as well as various electronics required when voice is output by the loudspeaker (including: D/A converter, low-pass postfilter), as shown in FIG. 6. Ŝ(z) is the transfer function of 2^{nd} path estimation filter, used for approximating the 2^{nd} path transfer function. W₁(z) is the transfer function of anti-noise estimation filter, used for estimating in-ear anti-noises. W₂(z) is the transfer function of primary near-end voice estimation filter, used for estimating main near-end voice. W₃(z) is the transfer function of secondary near-end voice estimation filter, used for estimating secondary near-end voice.

Anti-noise estimation filter W₁(z) takes main external noise X₁(z) as its reference input signal, and outputs anti-noise −\hat{D}(z), with the relationship represented below:

−\hat{D}(z)=X₁(z)W₁(z)

Anti-noise −\hat{D}(z) is combined with remote voice G(z), and then with in-ear noise D(z) and secondary near-end voice Q₂(z) through the 2^{nd} path transfer function S(z), so the voice U(z) obtained by in-ear microphone can be expressed below:

$$\begin{matrix}U ( z ) = D ( z ) + {Q}_{2} ( z ) + ( G ( z ) - \hat{D} ( z ) ) S ( z ) \\ = G ( z ) S ( z ) + {Q}_{2} ( z ) + ( D ( z ) - \hat{D} ( z ) S ( z ) ) \\ = G ( z ) S ( z ) + {Q}_{2} ( z ) + R ( z )\end{matrix}$$

Where, R(z) is residual noise; if in-ear noise can be offset by anti-noise, U(z)=G(z)S(z)+Q₂(z), and

D(z)=\hat{D}(z)S(z)

If substituting D(z)=X₁(z)P(z) and −\hat{D}(z)=X₁(z)W₁(z) into the above-specified formula, the optimal solution of W₁(z) is as follows:

$${W}_{1 , opt} ( z ) = - \frac{P ( z )}{S ( z )}$$

In other words, if anti-noise estimation filter W₁(z) can estimate both the transfer function of primary path and counter-transfer function of 2^{nd} path, it is possible to estimate in real-time the efficient in-ear anti-noises for noise cancellation. FXLMS algorithm used by anti-noise estimation filter W₁(z) requires it to be converged properly to the optimal solution, so correct residual noise shall be used as the basis of adjusting the filter parameters. In addition to residual noise, the voices obtained by in-ear microphone also contain remote voices G(z)S(z) and secondary near-end voice Q₂(z), thus the residual noise cannot be obtained directly.

Through 2^{nd} path estimation filter Ŝ(z), the remote voices G(z) in the present invention are used for approximation of the remote voice contents G(z)S(z) contained by in-ear microphone, so the estimated value of secondary near-end voice and residual noise is acquired by voice of in-ear microphone U(z) minus G(z)Ŝ(z):

$$\begin{matrix}{U}_{1} ( z ) = U ( z ) - G ( z ) \hat{S} ( z ) \\ = G ( z ) ( S ( z ) - \hat{S} ( z ) ) + {Q}_{2} ( z ) + R ( z ) \\ = {\hat{Q}}_{2} ( z ) + \hat{R} ( z )\end{matrix}$$

Where, S(z)−Ŝ(z)≈0. To further remove the estimated value \hat{Q}₂(z) of secondary near-end voice, the primary near-end voice estimation filter W₂(z) and secondary near-end voice estimation filter W₃(z) of the present invention shall be required.

The reference input signal of primary near-end voice estimation filter W₂(z) is main external noise X₁(z), and the target input signals are main near-end voice and secondary external noise obtained by the speaking microphone, Q₁(z)+X₂(z). Assuming that the main near-end voice Q₁(z) is not statistically interrelated with the secondary external noise X₂(z), and the main external noise X₁(z) is highly interrelated with the secondary external noise X₂(z), the output signal of primary near-end voice estimation filter W₂(z) is the content of target input signal related to reference input signal, when the parameter of primary near-end voice estimation filter W₂(z) is converged to the optimal solution. In other words, the output signal of primary near-end voice estimation filter W₂(z) is the estimated value \hat{X}₂(z) of secondary external noise, and error signal (Q₁(z)+X₂(z)−\hat{X}₂(z)) is the estimated value \hat{Q}₁(z) of main near-end voice. The estimated value \hat{Q}₁(z) of main near-end voice is main near-end voice after noise cancellation, which can be sent out.

The reference input signal of secondary near-end voice estimation filter W₃(z) is the estimated value \hat{Q}₁(z) of main near-end voice, and the target input signal is the estimated value \hat{Q}₂(z)+\hat{R}(z)) of U₁(z) (secondary near-end voice and residual noise). Assuming that the estimated value \hat{Q}₂(z) of secondary near-end voice is not statistically interrelated with the estimated value \hat{R}(z) of residual noise, and the estimated value \hat{Q}₁(z) of main near-end voice is highly interrelated with the estimated value \hat{Q}₂(z) of secondary near-end voice, the output signal of secondary near-end voice estimation filter W₃(z) is the content of target input signal related to reference input signal, when the parameter of secondary near-end voice estimation filter W₃(z) is converged to optimal solution. In other words, the output signal of secondary near-end voice estimation filter W₃(z) is the estimated value \hat{Q}₂(z) of secondary near-end voice, and error signal is the estimated value \hat{R}(z) of residual noise. Thus, the estimated value \hat{R}(z) of residual noise may provide a basis for adjusting the parameters by anti-noise estimation filter.

The adaptive control system of the present invention for estimating 2^{nd} path transfer function is shown in FIG. 6, wherein system identification principle is used for estimation of 2^{nd} path. In the adaptive control system, a white random signal generator is provided to generate white random signals (containing all frequencies) as the training signals for system identification. The white random signals are input simultaneously to 2^{nd} path estimation filter Ŝ(z), as well as real 2^{nd} path S(z) (including: D/A converter, low-pass postfilter, loudspeaker, 1-D sound field in the earphone, microphone, preamplifier, low-pass prefilter and A/D converter). In the event of little output difference, i.e. V(z)S(z)−V(z)Ŝ(z)≈0, the 2^{nd} path estimation filter Ŝ(z) can be used for approximation of real 2^{nd} path S(z). In FIG. 6, the reference input signal of 2^{nd} path estimation filter Ŝ(z) is a white random signal, and the target input signal is the result Y(z) of white random signal passing through the real 2^{nd} path. When the parameter of 2^{nd} path estimation filter Ŝ(z) is converged to the optimal solution, the error signal E(z) is minimized, i.e. E(z)=Y(z)−Ŷ(z)≈0, the 2^{nd} path estimation filter Ŝ(z) can be used for approximation of real 2^{nd} path S(z).

1. An apparatus for noise cancellation of voice communication, the apparatus comprising:
a main body;
a loudspeaker, being arranged in the main body for output of anti-noises and remote voices;
an in-ear microphone, being arranged in the main body nearby the loudspeaker and being comprised of a mini microphone used to acquire near-end voices in the earphone, said voices comprising residual noise, remote voice and secondary near-end voice;
an external noise microphone, being arranged externally on the main body and being comprised of a single-directional microphone used to acquire the noises outside of the main body, and being arranged to receive the near-end voices from speakers;
a speaking microphone, being arranged in the main body and being comprised of an omnidirectional microphone used to receive the near-end voices from the speakers as well as environmental noises; and
an adaptive control system, being comprised of a digital signal processor, an anti-noise estimation filter, primary near-end voice estimation filter and secondary near-end voice estimation filter, main external noise obtained by the external noise microphone being taken as the reference input signal of anti-noise estimation filter.

2. The apparatus for noise cancellation defined in claim 1, wherein the main body of voice communication apparatus is comprised of a two-way voice communication system covering external earphone microphone, headphone microphone, mobile phone and fixed telephone.

3. The apparatus for noise cancellation defined in claim 1, wherein the adaptive control system is arranged independently outside of the main body, or in the main body.

4. A method for noise cancellation of voice communication using the apparatus according to claim 1, the method comprising the steps of:
mounting an external noise microphone onto the main body; and
using the external noise microphone as a single-directional microphone to acquire the noise outside of the main body, which is taken as the reference noise signal of adaptive control system.
